(19) United States
(12) Patent Application Publication
(10) Pub. No.: US 2003/0016929 A1
(43) Pub. Date: Jan. 23, 2003

(54) Structure of optical intensity modulator array with block waveguide

(76) Inventor: Jung-Hwan Cho, Songnam-shi (KR)

Correspondence Address: CHA & REITER, 411 HACKENSACK AVE, 9TH FLOOR, HACKENSACK, NJ, 07601, US

(21) Appl. No.: 10/108,726

(22) Filed: Mar. 28, 2002

(30) Foreign Application Priority Data
Jul. 21, 2001 (KR) 2001-44008

(51) Int. Cl. G02B 6/10; G02B 6/12

(52) U.S. Cl. 385/132; 385/1; 385/14

(57) ABSTRACT

A planar lightguide circuit with the optical intensity modulator array structure capable of generating less influence upon the adjacent channels, by inserting a block optical waveguide between optical channels formed in a planar lightguide circuit chip having the optical intensity modulator array. The circuit is provided with a plurality of channel arrays each including an input waveguide, a waveguide modulation region connected to the input waveguide, for modulating an input light wave, an output waveguide connected to the waveguide modulation region, for outputting the modulated light wave, and a modulating unit for modulating the light wave that is disposed in the vicinity of the waveguide modulation region. The circuit chip further includes at least one first channel having a first optical intensity modulator provided with said modulating means, at least one second channel having a second optical intensity modulator provided with the modulating unit, and at least one block waveguide arranged between the first and second channels, for blocking the mutual interference between the light waves in the adjacent channels.

### PRIORITY

This application claims priority from an application entitled “Optical Intensity Modulator Array Structure With Block Waveguide” filed in the Korean Industrial Property Office on Jul. 21, 2001 and assigned Serial No. 2001-44008, the contents of which are hereby incorporated by reference.

### BACKGROUND OF THE INVENTION

1. Field of the Invention

The present invention relates generally to a planar lightguide circuit (PLC) for use in optical communication systems. Moreparticularly, the present invention relates to an optical intensity modulator array structure with block waveguide.

2. Description of the Related Art

The planar lightguide circuit (PLC) technique has been widely used in the the prior art for manufacturing the optical structure of waveguide elements for implementing the desired optical characteristics on a single substrate. This technique utilizes a total reflection phenomenon that occurs between a medium having a high refractive index, and a medium having a low refractive index.

The basic principle applied to the planar lightguide circuit technique is substantially identical to the principle applied to the propagation of light waves in fiber optics. This technique, which is usually provided with a manufacturing process quite similar to that of semiconductor devices, conventionally has various advantages such as effective and easy miniaturization and integration of optical components, good reproduction, high productivity or low cost on manufacturing of the optical devices.

In particular, the planar lightguide circuit technique is particularly important for the implementation of the new technology of optical devices, e.g., such as those with opto-electro integrated circuits or optical integrated circuits, because a diversity of optical components can be manufactured on a single substrate, including an optical source for producing optical signals, a passive component for processing the optical signals, or an optical detector for sensing the optical signals, or a combination thereof.

The PLC technique makes it possible to reduce the effective volume size of those optical components occupied in the optical communication systems, and such a planar lightguide circuit usually functions as a printed circuit board mainly used in manufacturing conventional electronic circuit devices. The optical communication system with the PLC technique provides more stability of operation as compared to the prior art systems.

A variety of techniques have been employed in the art to produce an optical medium and a lightguide that are optimally suited to any desired optical characteristic upon manufacturing a single chip of optical communication module by utilizing the PLC technique. In this field of the art, two types of techniques are generally utilized to control the desired optical intensity. The first technique is to use a cut-off optical modulator, in which the refractive index of an optical component is adjusted using heat, or external signals from electrodes, in order to decrease the optical intensity, thereby leading to the non-propagating condition of an optical signal. Then, the second technique is an optical phase technique. a typical structure of which may be seen in a Mach-Zender interferometer. In this type of technique, the adjustment in optical intensity of the optical signal is usually carried out so that either one of two separate optical signals split from a single lightguide is subjected to modulation in its refractive index so as to make a shift in optical phase of the split optical signal, and subsequently those signals are re-combined using the interference phenomenon in the optical signals.

Of the above two techniques, an operating point of the cut-off optical modulator is normally set in an optical manner, so there would be no need to provide any direct-current bias for setting such an operating point. Accordingly, this technique can be used in the optical communication system without any special additional devices, because it has a small degree of drifts in the operating point caused by influence from external circumstances. Further, the cut-off optical modulator has a wide dynamic range owing to its linear output characteristic relative to input voltages applied.

With regard to the optical phase technique, the optical components utilizing the optical phase, such as in the Mach-Zender interferometer, are adapted to modulate the optical signals in a range of optical phase of 0 to 2π and as a result, they have the non-linear output characteristic such as a sine or a cosine function. Therefore, the above-mentioned cut-off optical modulator may be useful, in particular, for the control of optical intensity, e.g., in analog communication systems. Furthermore, the cut-off modulator can be easily employed with a digital communication system without addition of any particular signal processing devices because it would be allowed to obtain digital output characteristic under a waveguiding condition in a particular optical waveguide.

The cut-off optical modulator is usually configured in a single block of an optical component with only inherent optical characteristics , so it most likely needs to be coupled in alignment with an optical fiber block for inputting or outputting the optical signal to/from other optical components or systems. For use in an input optical signal, this optical fiber block is usually adapted to use a single core of optical fiber block, whereas for use in an output optical signal, the optical fiber block is adapated so as to be provided with one or more optical fiber blocks, depending upon the number of output ports for the output optical signals. In one of the prior art optical components, the interval in between those optical fiber output ports is typically about 250 μm, possibly decreasing up to about 127 μm in some of those optical components implemented in the recent years.

Accordingly, research has been acitvely carried out in the art for optical components utilizing the high difference in a relative refractive index for the purpose of reducing the size of the optical component. The more reduced are the intervals in between those optical fiber output ports, the more decreased will be the total size of such an optical component, thereby resulting in the smaller size of the optical communication system, particularly when compared to the prior art. Recently, as there has been an ever-increasing demand for larger capacities of information to be transmitted, there has been a sharp expansion of optical communication systems and their associated subscriber networks. In fact, the optical components having multiple channels are in much greater demand than in the past, in particular, in the field of wavelength division multiplexing (WDM) optical communication systems.

However, in all those known techniques, whether the goal is the size reduction of optical components, or an the increase in number of channels, or the direct/indirect modulation of refractive index by the cut-off optical modulator can all have one critical disadvantage in that the multiplicity of optical channels influence each other's adjacent channels, thereby causing an unwanted change in the inter-channel characteristic. More specifically, the above techniques may be more often subject to a coupling between adjacent optical channels, or a failure of optical waveguiding condition in a certain channel, or consequently the radiation loss in a light wave failing to satisfy a basic waveguide mode. As a result, such a radiation loss will eventually lead to adverse effect on the optical characteristics or properties in any adjacent channels.

### SUMMARY OF THE INVENTION

It is, therefore, an object of the present invention to provide a planar lightguide circuit with the optical intensity modulator array structure capable of generating less influence upon the adjacent channels, by inserting a block optical waveguide between optical channels formed in a planar lightguide circuit chip having the optical intensity modulator array.

It is another object of the present invention to provide the optical intensity modulator array structure of a planar lightguide circuit capable of providing the minimum radiation loss in the optical waveguide.

According to one aspect of the present invention, a planar lightguide circuit chip is provided with a plurality of channel arrays, each array including an input waveguide, a waveguide modulation region connected to the input waveguide for modulating an input light wave, an output waveguide connected to the waveguide modulation region for outputting the modulated light wave, and a modulating means disposed in the vicinity of the waveguide modulation region, wherein the planar lightguide circuit chip includes at least one first channel having a first optical intensity modulator provided with said modulating means, at least a second channel having a second optical intensity modulator provided with the modulating means, the second optical intensity modulator being configured in the similar way to the first optical intensity modulator, and at least one block waveguide arranged between the first and second channels, for blocking the mutual interference between the light waves in the adjacent channels.

Preferably, the planar lightguide circuit chip is arranged so that the first and second optical intensity modulators are formed with tapered waveguides.

Preferably, the first and second optical intensity modulators may be formed with electro-optic material selected from materials consisting of semiconductor material such as GaAs or InP, ferroelectrics materials, such as LiNbO₃ or LiTaO₃, or a poled polymer.

Preferably, the first and second optical intensity modulators may be arranged to use the perpendicular direction of an electric field component.

Preferably, the first and second optical intensity modulators are respectively arranged to use either one of an electrode applied by an external signal and a microheater.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view of a planar lightguide circuit chip provided therein with a block optical waveguide according to a preferred embodiment of the present invention;

FIG. 2 is a plan view of the planar lightguide circuit of FIG. 1;

FIG. 3 is a graphic diagram illustrating the optical intensity in case where an optical signal is applied to first and second channels and an external signal is applied to a first optical intensity modulator, according to the present invention;

FIG. 4 is a graphic diagram illustrating the optical intensity according to a blocked condition or a non-blocked condition of the waveguide in case where an optical signal is applied to first and second channels and an external signal is applied to a first optical intensity modulator, according to the present invention; and

FIG. 5 is a graphic diagram illustrating the optical intensity according to a blocked condition or a non-blocked condition of the waveguide in case where an optical signal is applied to first and second channels and an external signal is applied to first and second optical intensity modulators, according to the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

Firstly, the structure of the optical intensity modulator arrays provided therein with a block optical waveguide according to a preferred embodiment of the present invention will be described.

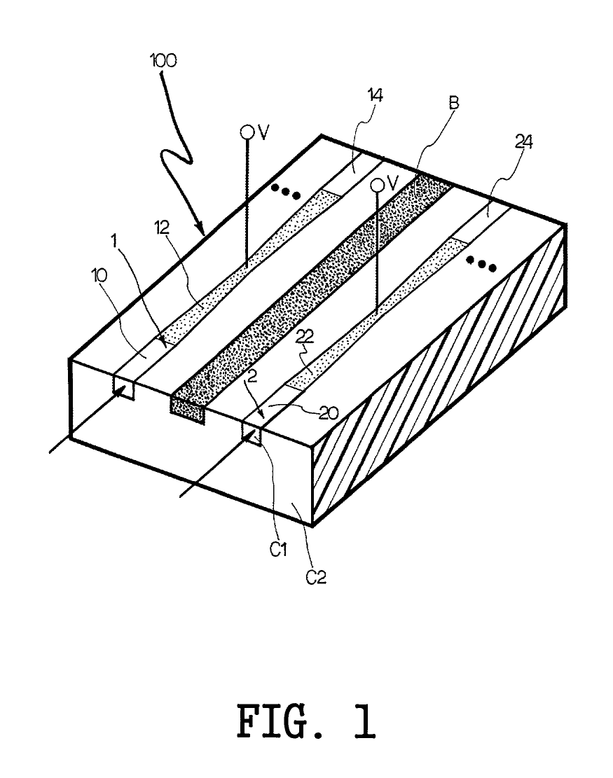

Referring to FIG. 1, preferred embodiment of the present invention shows a perspective view of a planar lightguide circuit chip 100 having optical intensity modulator arrays, and between the modulator arrays is inserted a block optical waveguide B.

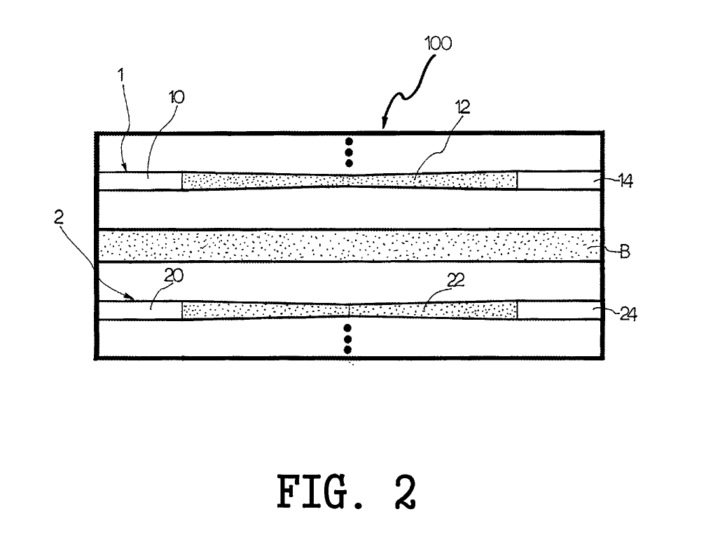

FIG. 2 illustrates a plan view of the planar lightguide circuit chip 100 shown in FIG. 1.

As seen in the FIGS. 1 and 2, the planar lightguide circuit chip 100 includes in its upper surface a channel array formed in optical waveguides configured to propagate therein a specified wavelength of light waves. As a matter of convenience for illustrative purposes only, the drawings show only a first channel 1 and its adjacent channel 2 of a multiplicity of channels in the channel array, and only a first optical intensity modulator 12 in the first channel 1 and a second optical intensity modulator 22 in the second channel 2. It is to be understood by the artisan that a multitude of of channels and adjacent channels can be present.

The first and second channels 1 and 2 each comprise a core C1 and its surrounding cladding C2, serving as an optical path for a light wave. The first channel 1 includes a first input waveguide 10, a first optical intensity modulator 12 and a first output waveguide 14. Similarly, the second channel 2 includes a second input waveguide 20, a second optical intensity modulator 22 and a second output waveguide 24. To the first and second input waveguides 10 and 20 is inputted the light wave for propagation, i.e., an optical signal. The respective first and second optical intensity modulators 12 and 22. disposed in contact with the respective first and second input waveguides, serve as the waveguiding regions for modulating the refractive index by means of an external signal, to which regions application of the external signal causes the modulation of optical intensity of the optical signal, substantially functioning as an electrode or a microheater respectively.

The first and second input waveguides 10 and 20 and the first and second output waveguides 14 and 24 are respectively formed as straight-type waveguides, while the first and second optical intensity modulators 12 and 22 are respectively formed as tapered-type waveguides. Preferably. the width of the respective first and second optical intensity modulators 12 and 22 is configured to have a width for generating no optical loss. Here, it should be appreciated that the physical properties of the media of the waveguides manufactured according to the form of modulating the refractive index in the first and second optical intensity modulators 12 and 22 differ from each other. In the case where the first and second optical intensity modulators 12 and 22 each are applied by an external signal being used as the respective electrode, it is utilizing the “electro-optic” effect, while in case where a microheater is being used, then it is utilizing the “thermo-optic” effect.

The typical electro-optic material widely used in this field of the art may include semiconductor material such as GaAs or InP, ferroelectrics material such as LiNbO₃ or LiTaO₃, or a poled polymer. When an electric field is applied into such an electro-optic material in a given fixed direction, the refractive index in the direction of the electric field or in its perpendicular direction changes. Therefore, it will be appreciated that as the change in the refractive index of the optical medium means a change in the optical phase of the light wave propagating through the medium, an optical phase modulator. i.e., the optical intensity modulator according to the present invention can be implemented using such change. The optical intensity modulator utilizing the electro-optic effect is provided in the vicinity of a waveguide with a capacitor type of electrodes for applying the electric field into the waveguide, to which electrodes a fixed voltage is applied to generate the electric field.

Contrary to the electro-optic effect. almost all of the optical materials have some degree of the thermo-optic effect. The first and second optical intensity modulators 12 and 22 may be formed with such a thermo-optic material selected from materials comprising semiconductor material such as GaAs or InP, ferroelectrics material such as LiNbO₃ or LiTaO₃, poled polymer, or silica, or the like. As the temperature changes, the refractive index of the optical medium comprising of the above thermo-optic material changes owing to contraction or expansion in its volume. Therefore, the thermo-optical effect also makes it possible to effect the phase modulation or the optical intensity modulation in the light wave, in a similar way to the electro-optic effect. The optical intensity modulator utilizing the thermo-optic effect is provided in the vicinity of the waveguide with a microheater for applying the heat into the waveguide, to which microheater a given amount of electric current is applied to generate the heat. The thermo-optic effect is allowed to have the diversity of selecting any desired materials, in comparison to the electro-optic effect, for it usually appears with a quite remarkable degree in almost all of the optical materials used in the art. The first and second output waveguides 14 and 24, are respectively coupled with the first and second optical intensity modulators 12 and 22, and serve to transfer the modulated optical signal to an output optical fiber block (not shown) or other optical components where appropriate.

According to the preferred embodiment of the present invention, a strip of block waveguide, indicated by a symbol B of FIGS. 1 and 2, is inserted in between the adjacent two optical channels, more specifically, between the two adjacent (e.g., first and second of the disclosed embodiment) optical intensity modulator arrays, in which the block waveguide is provided to obtain better optical characteristic for the first and second optical intensity modulators 12 and 22.

Experiments

Hereinafter, the description will be made on the experiment for comparison of a specific optical characteristic, for example, the optical intensity according to a blocked condition or a non-blocked condition of the waveguide, in which the block waveguide is arranged between two adjoining optical intensity modulator arrays. To evaluate the optical characteristic respectively obtained from either a blocked condition or a non-blocked condition of the block waveguide B according to the preferred embodiment of the present invention, a computerized simulation was carried out utilizing a beam propagation method (BPM) with the following structure.

The refractive index of the waveguide in cladding layer C2 was 1.44 and the refractive index in the core layer C1 was a refractive index corresponding to 0.45% of the relative refractive index, and the wavelength was set to 1.55. The tapered waveguides 12 and 22, which are the typical structure for the cut-off type of optical modulator, were defined as the regions for modulating the respective refractive index according to the invention. The width of the first and second input waveguides 10 and 20 was set to 6.5 which functions as the optical waveguide for guiding the basic mode of the light wave. The width of the tapered waveguides 12 and 22 was set to 4.5. The above particular setting of widths in those waveguides is configured to generate no loss for the waveguides before applying the external signal.

Two cut-off optical modulator arrays for carrying out the above simulation, e.g., the first and second optical modulators 12 and 22, are provided by way of example, wherein a comparison is made between the blocked (existence) condition of the block waveguide B and the non-blocked (non-existence) condition of the block waveguide B, between these first and second optical modulators. Here, an interval between the two cut-off optical modulator arrays, i.e., the first and second optical modulators 12 and 22, was set to 50, and the block waveguide B is arranged in the center of the interval between the first and second optical modulators, that is, spaced apart from each of the optical modulators by about 25, so that there is no coupling between three waveguides, during the condition of not having a modulation signal. Using these conditions, a comparison will be made between the first case of applying the external signal to the first channel 1 only and the second case of applying the same external signal to both of the first and second channel and 2 simultaneously.

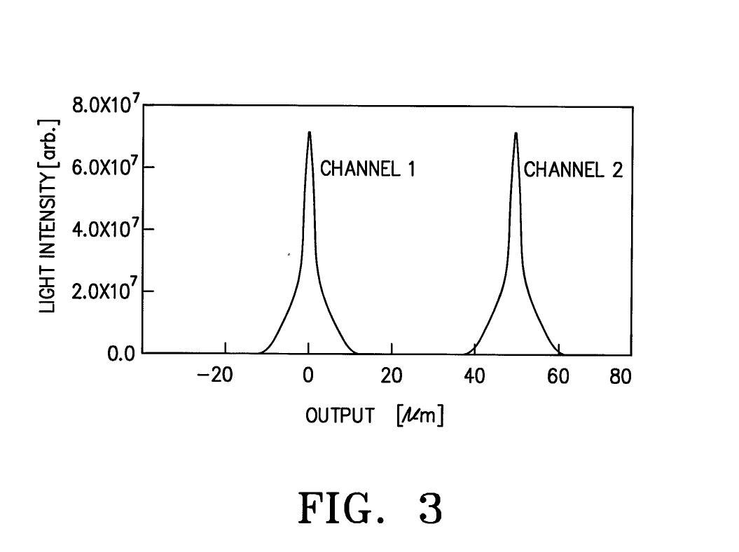

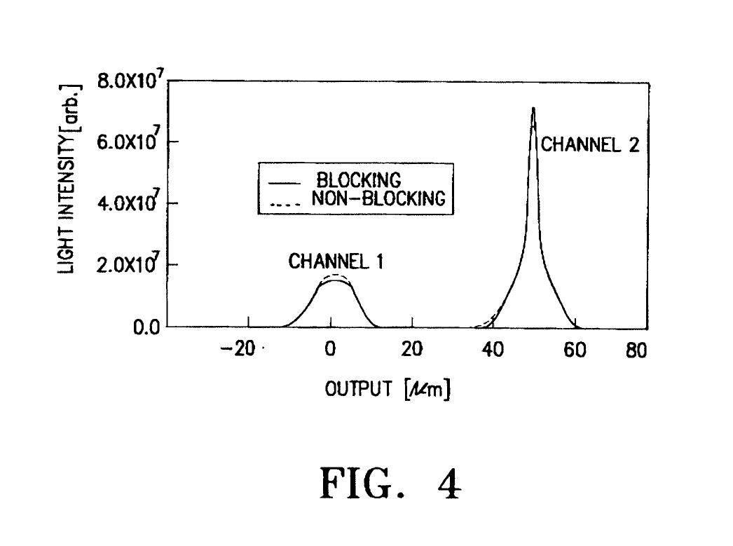

Referring now to FIG. 3, there is illustrated the optical intensity in the optical signals respectively applied to the first and second optical modulators 12 and 22. Referring further to FIG. 4, there is illustrated the optical intensity in the output end, in case the external signal is applied to the first optical intensity modulator only according to the present invention. Thus, its graphic diagram respectively shows the optical intensity of the light wave in either the blocked condition or the non-blocked condition of the block waveguide B, wherein in the non-blocked condition, the output light wave in the output stage of the second channel 2 indicates that a part of the light beam radiated from the first channel 1 is optically being coupled with the second channel. This phenomenon will mean that the center of the output light wave of the second channel 2 is also biased toward the first channel.

However, it is noted that under the blocked condition of the block waveguide B, the influence to the second channel by the light wave radiated from the first channel is relatively small, as seen in the graph of FIG. 4. Thus, it is shown that the light wave in the second channel propagates in the same way to its own original waveguiding condition in comparison to the input optical signal. Here, it will be apparent that the block waveguide B should be designed in such a way that its interval and width could meet the physical condition of generating no coupling between the cut-off optical modulator arrays.

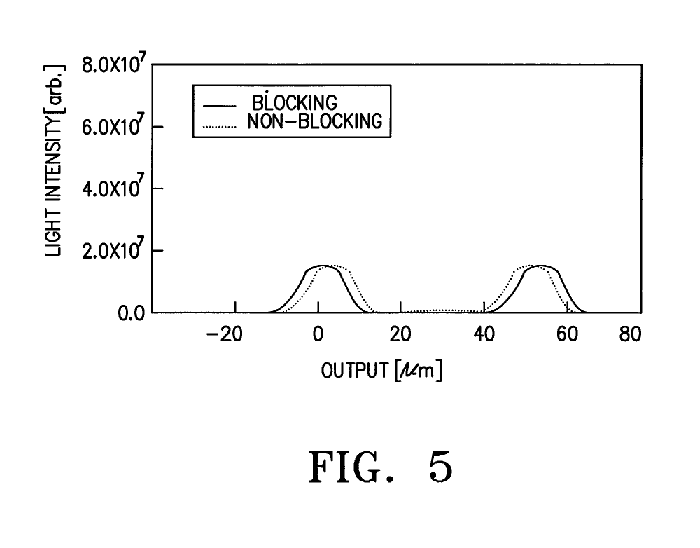

Referring to FIG. 5, it is illustrated that the optical intensity in output according to a blocked condition or a non-blocked condition of the block waveguide in a case where the optical signal is applied to the first and second channels and the external signal is applied to the first and second optical intensity modulators. Its graphic diagram shows more clear result as compared to the result obtained with reference to FIG. 4. Therefore, it is noted that the optical signal modulated without the block waveguide will give a considerable degree of influence upon its adjacent channels, while the application of the block waveguide between the optical channels according to the present invention will prevent such adverse influence, e.g., the coupling phenomenon due to much radiation loss.

As apparent for the foregoing description, the present invention provides better optical characteristics for an optical intensity modulator by way of appropriately inserting a block waveguide between the respective adjacent ones of the optical intensity modulator arrays in a planar lightguide circuit for use in the optical communication system.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A planar lightguide circuit chip comprising:
a plurality of channel arrays each one of said channel arrays including an input waveguide, a waveguide modulation region for modulating an input light wave, said waveguide modulation region being connected at a first end to the input waveguide, an output waveguide for outputting the light wave modulated by the waveguide modulation region, said output waveguide being connected to a second end of the waveguide modulation region, and said each one of said channel arrays having a modulating means for modulating the light wave in the waveguide modulation region, wherein said planar lightguide circuit chip further comprises:
said modulating means for said each one of said channel arrays having an optical intensity modulator array provided with said modulating means; and
at least one block waveguide array arranged between two adjacent channel arrays for preventing mutual interference between the optical intensity modulator of said two adjacent channel arrays.

2. A planar lightguide circuit chip comprising:
a plurality of channel arrays, each one of said channel arrays including an input waveguide, a waveguide modulation region for modulating an input light wave, said waveguide modulation region being connected at a first end to the input waveguide, an output waveguide for outputting the light wave modulated by the waveguide modulation region, said output waveguide being connected to a second end of the waveguide modulation region and said each one of said channel arrays having a modulating means for modulating the light wave in the waveguide modulation region, wherein said planar lightguide circuit chip further comprises: at least a first channel having a first optical intensity modulator provided with said modulating means;
at least a second channel having a second optical intensity modulator provided with said modulating means, said second optical intensity modulator having a configuration approximate to a configuration of said first optical intensity modulator; and
at least one block waveguide arranged between the first and second channels for blocking a mutual interference between the light waves in the first and second channels.

3. The planar lightguide circuit chip according to claim 2, wherein said first and second optical intensity modulators are formed with tapered waveguides.

4. The planar lightguide circuit chip according to claim 2, wherein said first and second optical intensity modulators are formed with electro-optic material selected from semiconductor material selected from the group consisting GaAs. InP, ferroelectrics material, and poled polymer.

5. The planar lightguide circuit chip according to claim 4, where the ferroelectric material comprises one of LiNbO₃ and LiTaO₃.

6. The planar lightguide circuit chip according to claim 2, wherein said first and second optical intensity modulators create an electric field and are arranged to use a perpendicular direction component of the electric field.

7. The planar lightguide circuit chip according to claim 2, wherein said first and second optical intensity modulators are formed with thermo-optic material selected from semiconductor materials selected from the group consisting of GaAs. InP, ferroelectric material, poled polymer, and silica.

8. The planar lightguide circuit chip according to claim 7, wherein the ferroelectric material comprises one of LiNbO₃ and LiTaO₃.

9. The planar lightguide circuit chip according to claim 2, wherein said first and second optical intensity modulators are respectively arranged for use with one of (a) an electrode applied with an external signal and (b) a microheater.

10. The planar lightguide circuit chip according to claim 1, wherein said respective optical intensity modulator array is formed with tapered waveguide.

11. A method for providing a planar lightguide circuit chip comprising the steps of:
(a) arranging a plurality of channel arrays on a chip, each one of said channel arrays including an input waveguide, a waveguide modulation region for modulating an input light wave, and an output waveguide for outputting the light wave modulated by the waveguide modulation region, said waveguide modulation region being connected at a first end to the input waveguide, said output waveguide being connected to a second end of the waveguide modulation region, and said each one of said channel arrays having a modulating means for modulating the light wave in the waveguide modulation region, wherein said planar lightguide circuit chip further comprises:
(b) forming a first optical intensity modulator with said modulating means to at least a first channel of said channel arrays;
(c) forming a second optical intensity modulator with said modulating means to at least a second channel, wherein said second optical intensity modulator having a configuration that is approximate to a configuration of said first optical intensity modulator; and
(d) arranging at least one block waveguide arranged between the first channel and second channel for blocking a mutual interference between the light waves in the first channel and second channel.

12. The method according to claim 11, wherein step (b) further includes forming said first optical intensity modulator with a tapered waveguide.

13. The method according to claim 11. wherein step (c) further includes forming said second optical intensity modulator with a tapered waveguide.

14. The method according to claim 11, wherein both the first optical intensity modulator in step (b) and the second optical intensity modulator formed in step (c) are formed with tapered waveguides.

15. The method according to claim 11, wherein modulation is applied to the first optical intensity modulator by an electrode connected to an external signal.

16. The method according, to claim 11, wherein modulation is applied to the first optical intensity modulator by a microheater.

17. The method according to claim 11, wherein modulation is applied to the first optical intensity modulator by an electrode connected to an external signal.

18. The method according to claim 11, wherein modulation is applied to the first optical intensity modulator by a microheater.

19. The method according to claim 11, wherein modulation is applied to the first optical intensity modulator and the second optical intensity modulator by electrodes connected to an external signal.

20. The method according to claim 11, wherein modulation is applied to the first optical intensity modulator and the second optical intensity modulator by a microheater.
